(19) United States
(12) Patent Application Publication
(10) Pub. No.: US 2026/0102923 A1
(43) Pub. Date: Apr. 16, 2026

(54) SELF-CLEANING ROBOTIC KITCHEN SYSTEM

(71) Applicant: Miso Robotics, Inc., Pasadena, CA (US)

(72) Inventors: Bachir Kharraja, Irvine, CA (US); Zachary Zweig Vinegar, Pasadena, CA (US); Richard Parks, Huntington Beach, CA (US); Hendry Joe, Irvine, CA (US); Nicholas Ardavin, Los Angeles, CA (US); Yusuke Kojitani, Pasadena, CA (US); Jonathan Cheng, Los Angeles, CA (US)

(21) Appl. No.: 19/344,071

(22) Filed: Sep. 29, 2025

Related U.S. Application Data
(60) Provisional application No. 63/707,099, filed on Oct. 14, 2024.

(51) Int. Cl. B25J 11/00; A47J 37/12; B25J 19/02

(52) U.S. Cl. CPC B25J 11/0045; A47J 37/12; B25J 11/0085; B25J 19/023

(57) ABSTRACT

A self-cleaning robotic kitchen system has a robotic arm, a camera or sensor, a cleaning tool and computer and electronics. The computer is programmed and operable to (a) determine whether to commence a first cleaning phase for cleaning a first section based on the at least one sensor or camera; (b) control pick up of the cleaning tool; (c) control the robotic arm to clean according to a predefined route or pattern to scrub the first section; (d) query whether the first section is clean; and (e) dock the cleaning tool if the first section is clean. Related methods are also described.

### CROSS-REFERENCE TO RELATED APPLICATIONS

This claims priority to application Ser. No. 63/707,099, filed Oct. 14, 2024, and entitled “SELF-CLEANING ROBOTIC KITCHEN SYSTEM” incorporated herein by reference in its entirety for all purposes.

### BACKGROUND OF THE INVENTION

### 1. Field of the Invention

This invention relates to kitchen appliances and more particularly to robotic kitchen apparatuses for automatic food preparation in a restaurant kitchen environment.

### 2. Description of the Related Art

There are a number of challenges associated with automatic food preparation in a restaurant or commercial kitchen, not the least of which is cleaning the cooking apparatuses. Examples of challenges include without limitation: labor shortages; accumulation of grease and debris; periodic and thorough cleaning without interrupting kitchen operations; and ensuring consistent performance and hygiene.

An improved system and method are desired to overcome the above-mentioned challenges, avoid disrupting the kitchen workflow, and fit in a small commercial kitchen environment.

### SUMMARY OF THE INVENTION

A self-cleaning robotic kitchen system comprises a cleaning tool, at least one sensor, and a processor programmed to execute a cleaning algorithm to control the robotic arm to move the cleaning tool across the dirty surface based on data arising from the at least one sensor.

In embodiments, the cleaning tool comprises a distal cleaning cartridge and a proximal body to which the robotic arm can grip. In embodiments, the distal cleaning cartridge has a tapered or cone shape and is comprised of a material adapted to remove grease and food debris. An exemplary material for the cartridge is a cellulose or polyester sponge or a cotton or synthetic fiber-based cloth.

In embodiments, the tool body includes feature(s) for the robotic arm to detachably grip. In embodiments, the tool body comprises an annular recess.

In embodiments, the distal cleaning cartridge is detachable from the tool body. In embodiments, the cleaning cartridge includes a socket for receiving a head (or drive) protruding from the tool body. In embodiments, the socket and head have a friction fit or optionally, a ball detent assembly to removably attach the cartridge to the tool body.

In embodiments, the system further comprises a receptacle for disposing the cleaning cartridge or the entire tool after it has been used. In embodiments, the receptacle includes a slot or opening for engaging an interface between the cartridge and the tool body to catch and split off the cartridge from the body.

In embodiments, the body can comprise an active mechanism to eject the cartridge such as ejector pins or an air jet to push off the cartridge from the head of the tool body.

In embodiments, the sensor or sensory mechanism comprises at least one sensor operable to detect grease and debris levels, as well as real-time kitchen activity. In embodiments, the sensor is a camera such as a RGB camera.

In embodiments, the cleaning algorithm is a machine learning algorithm for autonomously selecting an optimal cleaning time based on the image data arising from the sensor, cooking schedules and operational data. Examples of operational data could include, without limitation, opening hours, how often the fryer is used, how much is being cooked in the fryer, and how often is the fryer manually cleaned.

In embodiments, the self-cleaning robotic kitchen system further includes a computer or workstation having one or more memory devices, processors, and controllers. The memory preferably has a library of predetermined patterns or routes for cleaning the surfaces.

In embodiments, the computer is programmed to clean only a detected dirty region or spot based on sensed image data, by computing its 3D coordinates and directing the cleaning cartridge to that location.

The description, objects and advantages of embodiments of the present invention will become apparent from the detailed description to follow, together with the accompanying drawings.

### BRIEF DESCRIPTION OF THE DRAWINGS

FIG. 1 is a front right-side perspective view of a self-cleaning robotic kitchen system in accordance with an embodiment of the invention;

FIG. 2 is a partial rear perspective view of the self-cleaning robotic kitchen system shown in FIG. 1;

FIGS. 3A, 3B are enlarged isolated views of the robotic arm and cleaning tool in accordance with an embodiment of the invention;

FIG. 4 is a flow chart of a robotic-implemented process for cleaning the robotic kitchen system in accordance with an embodiment of the invention;

FIGS. 5A, 5B are enlarged isolated views of the robotic arm and cleaning tool in accordance with another embodiment of the invention;

FIG. 6 is a partial rear perspective view of the self-cleaning robotic kitchen system including a waste bin for depositing used cleaning tools in accordance with an embodiment of the invention;

FIG. 7 is a flow chart of a robotic-implemented multi-phase cleaning scheme in accordance with an embodiment of the invention;

FIG. 8 is an illustration a user interface of a self-cleaning robotic kitchen system in accordance with an embodiment of the invention;

FIG. 9 is a flow chart of a process for calibrating a robotic kitchen cleaning system in accordance with an embodiment of the invention;

FIG. 10 is a flow chart of a process for generating a cleaning path for a robotic kitchen cleaning system in accordance with an embodiment of the invention; and

FIG. 11 is a flow chart of a process for spot-cleaning using a robotic kitchen cleaning system in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Described herein is a robotic cleaning system.

### System Overview

This invention is directed to self-cleaning systems and methods for cooking food.

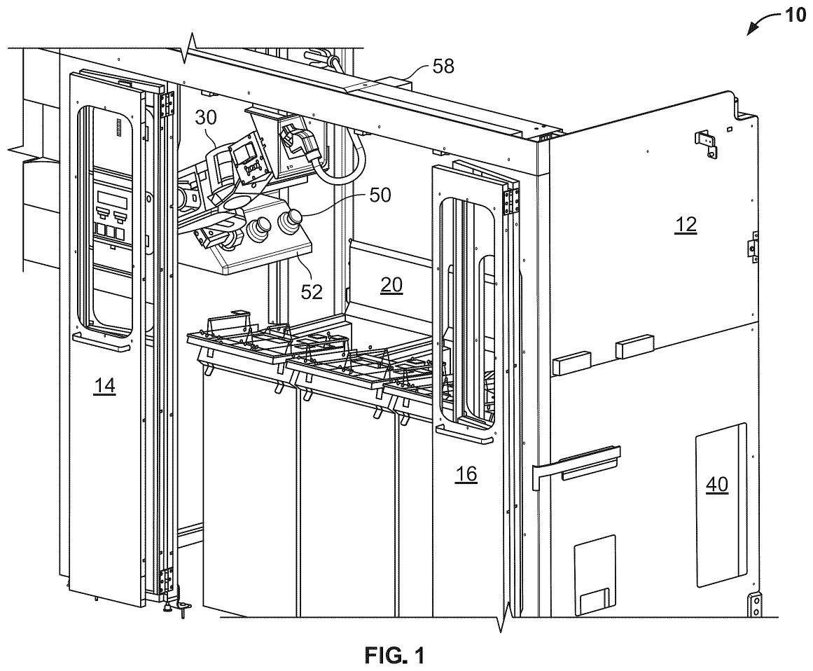

FIG. 1 shows a self-cleaning robotic kitchen system 10 in accordance with an embodiment of the invention. The robotic kitchen system 10 is shown including a fryer 20, robotic arm 30 operable to pick up and place a basket of raw food into the fryer 20. The robotic working space and fryers are surrounded by an enclosure 12. Folding doors 14, 16 are in an open configuration providing access to the internal assemblies. Electronics and computer may be arranged in the rear chamber 40 for controlling and monitoring all actions and schedules of the robotic kitchen system to automatically cook food. An example of a robotic kitchen system operable to automatically fry food is described in U.S. Pat. No. 12,082,742, filed Apr. 22, 2022, and entitled “AUTOMATED BIN SYSTEM FOR ACCEPTING FOOD ITEMS IN ROBOTIC KITCHEN WORKSPACE”, the entirety of which is incorporated herein by reference for all purposes.

System 10 additionally includes at least one cleaning tool 50 located in a tool exchange or dock 52. The dock 52 is shown supporting three cleaning tools. It includes three tool slots. However, the number of slots may vary and range from 2-10, and more preferably 3-6. Indeed, the dock may be configured to hold more or less cleaning tools, as well as different types of tools for use in cooking and cleaning.

In embodiments, one or more cameras and sensors 58 are arranged within the enclosure and aimed at the robotic workspace. A processor in the electronics chamber is programmed and operable to manage the robotic arm and other operations of the system as described herein. Non-limiting examples of robotic arms, sensors, and programmed processors for scheduling, image processing, object recognition, and controlling the components are described in, e.g., U.S. Pat. No. 10,919,144, filed Aug. 10, 2018, and entitled “MULTI-SENSOR ARRAY INCLUDING AN IR CAMERA AS PART OF AN AUTOMATED KITCHEN ASSISTANT SYSTEM FOR RECOGNIZING AND PREPARING FOOD AND RELATED METHODS”, incorporated herein by reference in its entirety for all purposes.

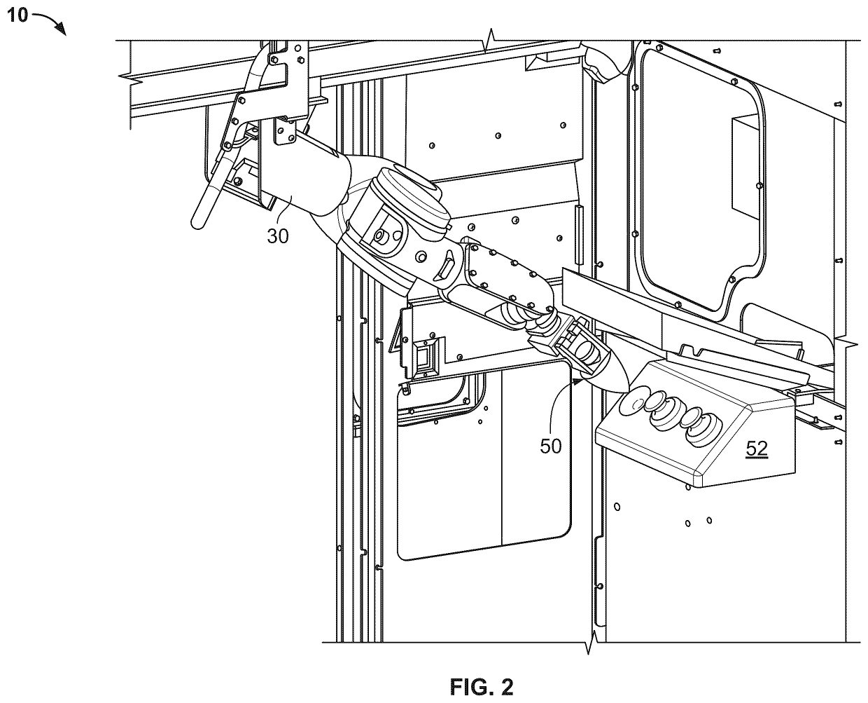

FIG. 2 shows the robotic arm 30 picking up and retrieving cleaning tool 50 from the tool exchange 52. The tool exchange 52 is shown mounted on the frame of the enclosure.

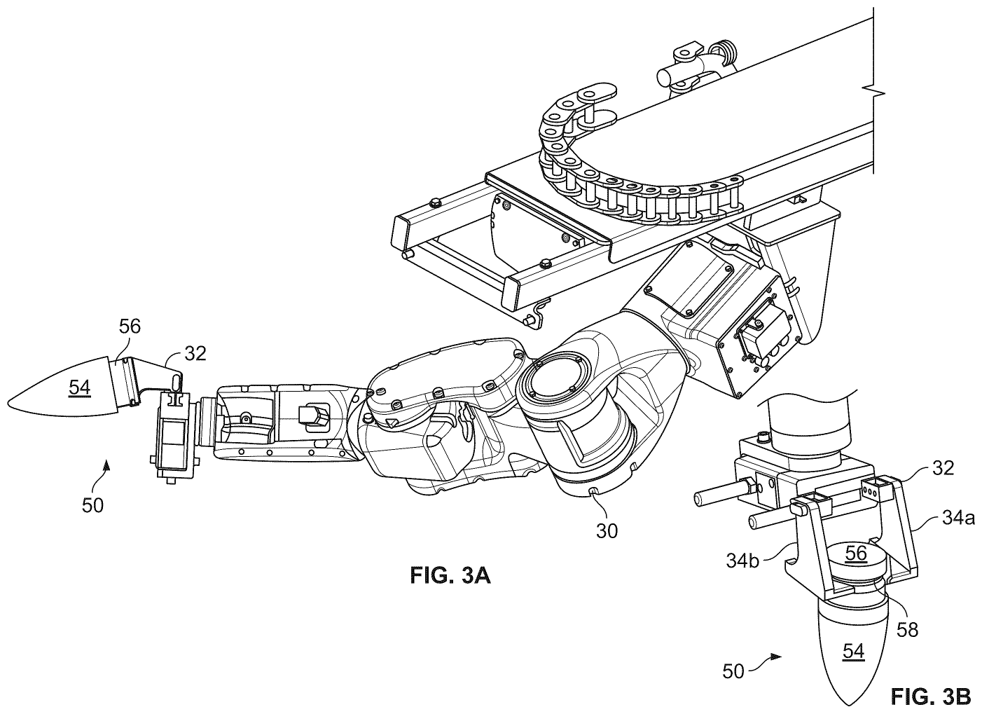

FIGS. 3A, 3B are isolated enlarged views of the robotic arm 30 and cleaning tool 50 in accordance with an embodiment of the invention. Cleaning tool is shown having a distal cone-shaped portion or cartridge 54 arranged on a tool body 56. With reference to FIG. 3B, the tool body 56 is shown being gripped by the robotic arm end effector 32. In particular, two jaws 34a, 34b are shown clamping onto an annular recess 58 in the tool body 56. The jaws 34a, 34b are shaped to match the annular recess 58 when the jaws close. In embodiments, each jaw has a semi-circular cutout to engage the annular recess on the tool body. An example of a robotic arm end effector is described in U.S. Pat. No. 11,167,421, filed Aug. 7, 2019, and entitled “ROBOTIC KITCHEN ASSISTANT INCLUDING UNIVERSAL UTENSIL GRIPPING ASSEMBLY”, incorporated herein by reference in its entirety for all purposes.

The cleaning cartridge 54 preferably comprises a material that can collect grease and debris. Exemplary materials are natural and synthetic sponges, fibers, and cloths.

In some embodiments, the cartridge is a composite including a backing and outer cover of the absorbent material. The backing may be somewhat more rigid to support the shape of the soft absorbent outer material. For example, a cardboard layer or wire skeleton can be arranged to support the softer absorbent cotton or fiber or sponge outer layer.

The shape of the cleaning cartridge may also vary. Although a cone shape is shown, other suitable shapes include without limitation: sphere, cylinder, spiral, planar disk, planar square or rectangle or mattress-like shape.

An exemplary characteristic diameter of the cartridge ranges 1-5 inches and more preferably from about 1-3 inches. An exemplary characteristic length of a cone or cylinder ranges from 3-7 inches and more preferably from about 3-5 inches. In the case of a disk or mattress shape, an exemplary thickness ranges from 0.5 to 2 in.

### Cleaning Method

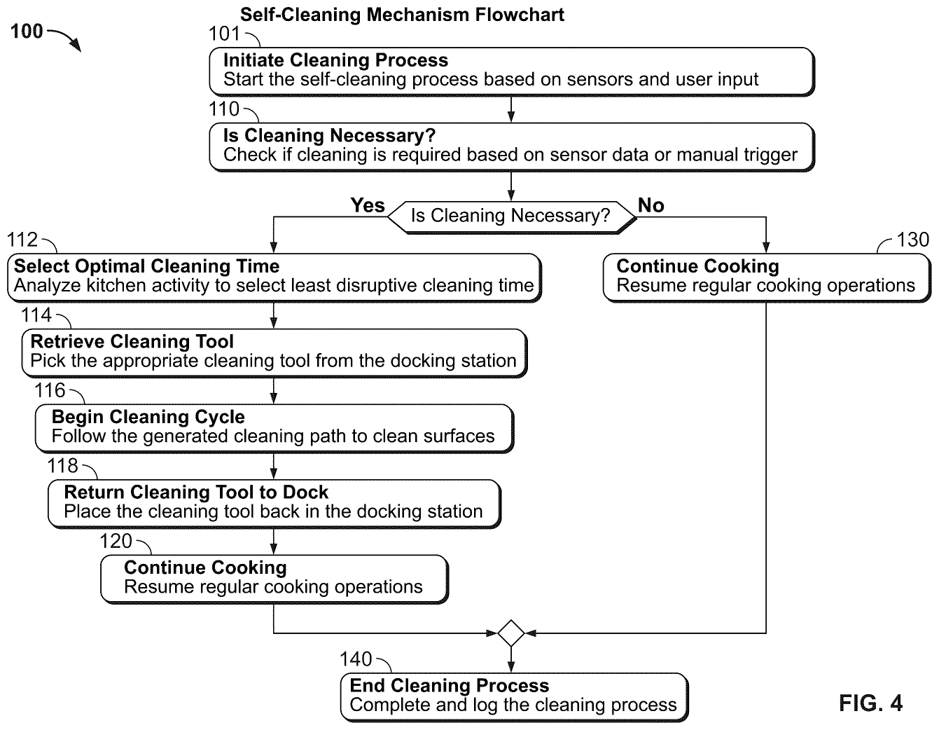

FIG. 4 is a flow chart of a method 100 for cleaning a surface of a robotic kitchen system (e.g., robotic kitchen system 10 shown in FIGS. 1-2).

Step 101 states start the cleaning process. This step may be performed manually by the user or automatically. For example, in embodiments, the cleaning is performed based on the time of day, or operating schedule of the restaurant, or schedule of orders.

Step 110 states whether cleaning is necessary. This step is performed by the processor and based on sensor data. The sensors continuously monitor the surfaces for grease and debris levels. Once the levels exceed a preset necessity threshold, the system identifies the need for cleaning.

In embodiments, color and reflectiveness is computed for the image data of the kitchen surfaces to determine whether grease is present.

If cleaning is unnecessary as determined per step 110, the system resumes cooking as described in step 130.

If, on the other hand, cleaning is necessary as determined per step 110, the process moves to step 112. Step 112 states to select optimal cleaning time. This step may be computed by the processor using machine learning algorithms. In embodiments, the processor is programmed and operable to analyze kitchen activity data to determine the least disruptive time of day for cleaning. This step can include evaluating current cooking tasks, scheduled downtimes, and historical data.

In embodiments, the cleaning time is set when there is a sufficient gap between adjacent orders. For embodiments, the system estimates how long the cleaning action will take, which can vary depending on how much and where it needs to be cleaned, then the system makes sure there is at least that much time between orders, plus a little buffer of at least 5, 10, or 30 seconds.

Step 114 states to retrieve the cleaning tool. With reference again to FIG. 2, at the selected optimal time, the robotic arm 30 retrieves the cleaning tool 50 from the docking station 52.

Step 116 states to begin the cleaning cycle. As described further herein, the system is programmed and operable to automatically move the cleaning tool across various surfaces of the appliances, frame, and enclosure according to various patterns, schemes, logic rules and algorithms. In embodiments, the system includes a predefined library of cleaning routes/path along each of the fryers and frame sections.

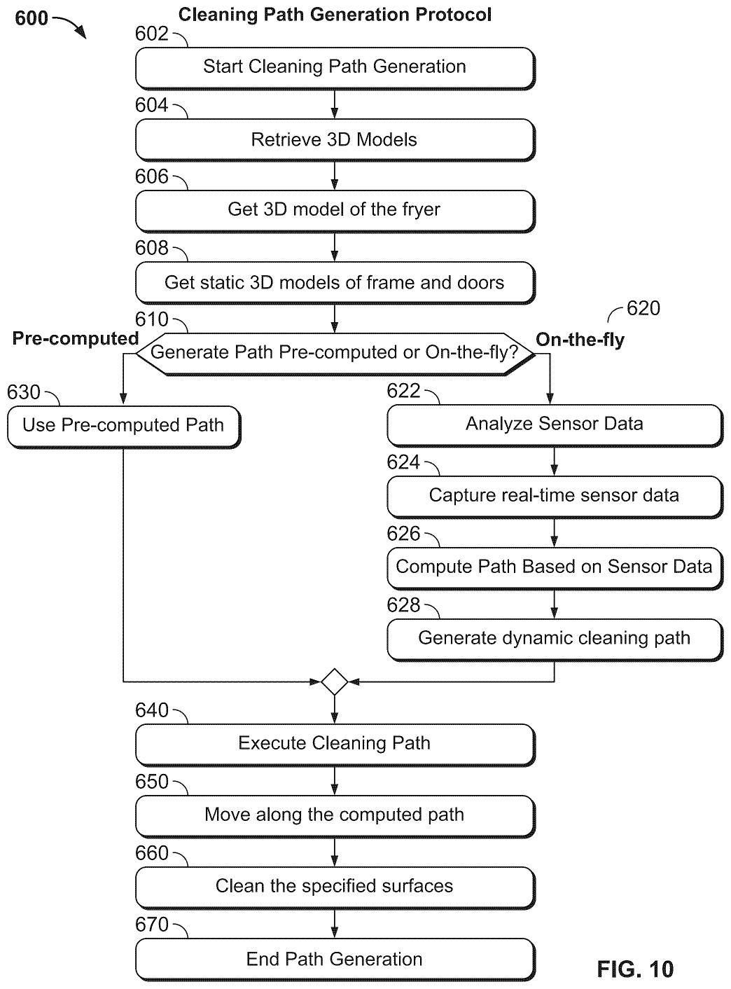

In embodiments, the system generates a cleaning path or route to clean the surfaces as described herein with reference to FIG. 10.

In embodiments, a pre-processing or setup step includes tracing each type of cleaning tool across an area to clean and labeling and storing the route in the system. A library of predefined routes can be created for each robotic workspace for cleaning.

Additionally, in some embodiments, the camera and sensor image data can be processed to determine a 3D coordinate area to clean. The processor can then instruct or command the robotic arm to clean the specific area as defined by the computed 3D coordinates.

Step 118 states to return cleaning tool to dock. This step is performed by the robotic arm 30 placing the cleaning tool 50 in the open slot in the dock 52, and releasing it therein.

Step 120 states continue cooking. This step is performed automatically by the robotic kitchen system according to customer orders and computed cooking schedule. For embodiments, the robotic arm picks up a basket of raw food and cooks it in the fryer.

Step 140 states end cleaning process.

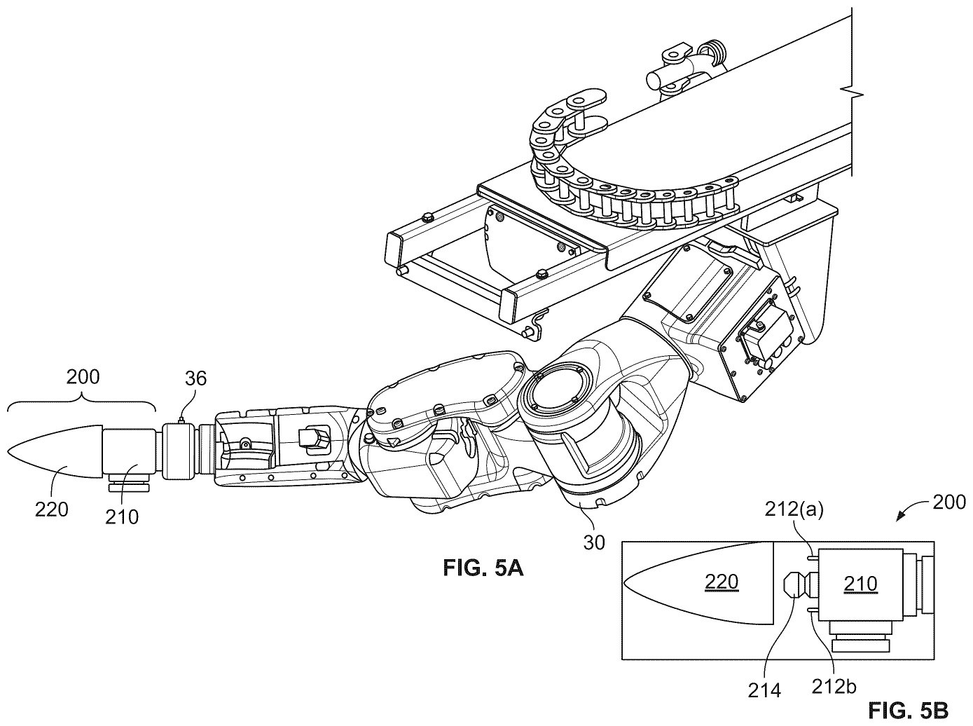

FIGS. 5A, 5B are isolated enlarged views of the robotic arm 30 and cleaning tool 200 in accordance with another embodiment of the invention. Similar to the embodiment described above, cleaning tool 200 is shown having a distal cone-shaped portion or cartridge 220. However, with reference to FIG. 5B, the cartridge 220 is detachably coupled to tool body 210 by a head or driver 214. In embodiments, the head or driver cooperates with a socket in the cartridge 220. Optionally, the tool body 210 is equipped with an active cartridge ejector mechanism such as ejector pins 212a, 212b for ejecting the cartridge from the tool body after use.

Then, the robotic arm 30 could go to a dock and put on a clean cartridge.

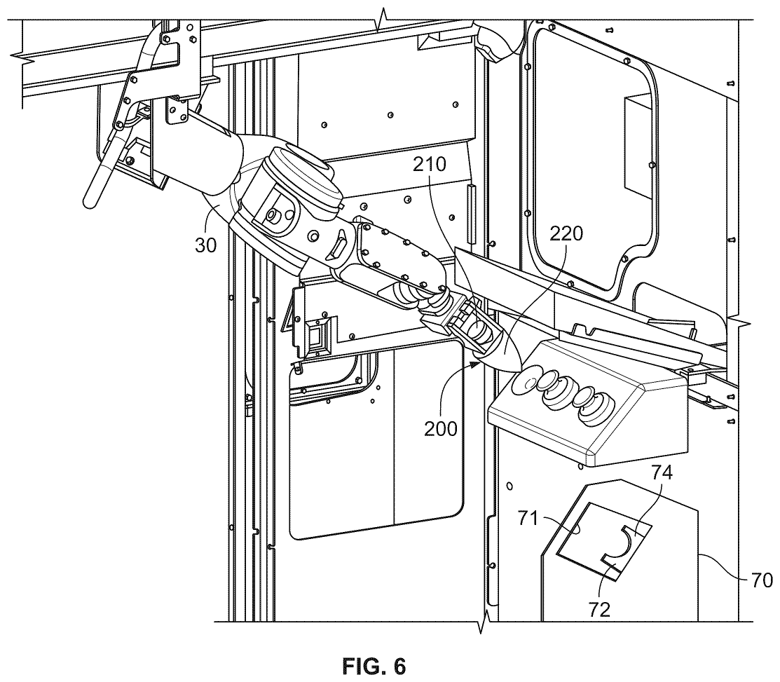

FIG. 6 illustrates a robotic system including a passive cartridge ejection implementation in accordance with an embodiment of the invention. The system includes a receptacle bin 70 for collecting used cleaning cartridges. The bin 70 includes a window 71 and a U-shaped fixture to engage the cartridge. Detents 72, 74 (optionally spring loaded) are shown shaped to engage or split the cartridge from the tool body 210. In an application, the robotic arm 30 manipulates the cleaning tool into the fixture such that the detents 72, 74 are fitted into an interface between the tool body 210 and the cartridge 220. The robotic arm then retracts the tool body from the bin 70, causing the cartridge 220 to separate from the tool body 210 and fall into the bin.

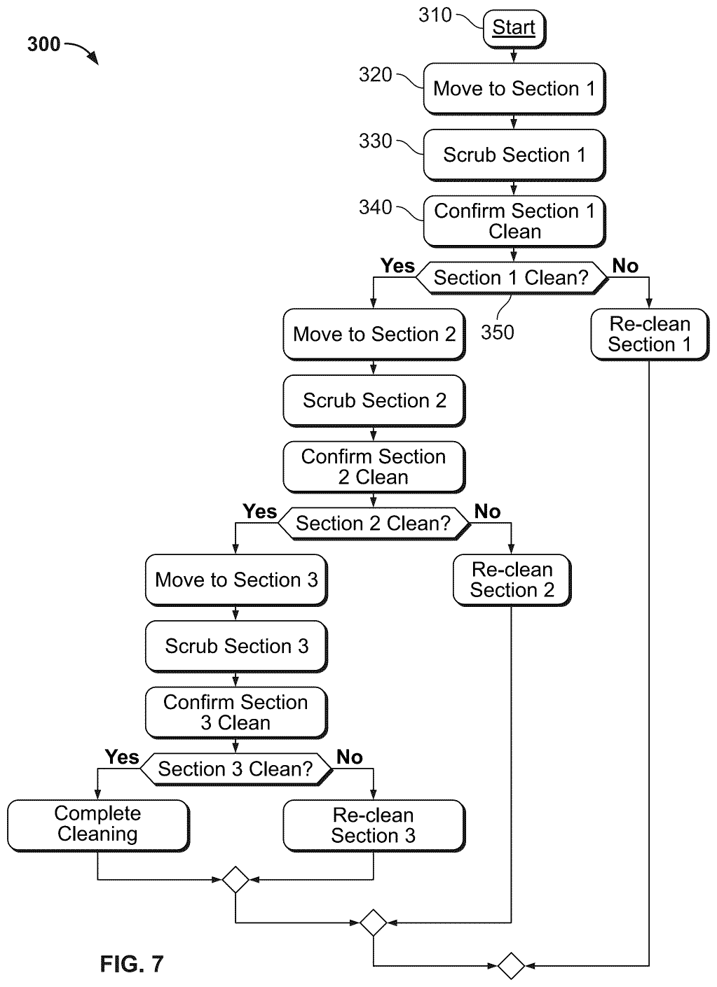

FIG. 7 is a flow chart of a multi-phase method 300 for cleaning a robotic kitchen according to embodiments of the invention.

Step 310 states start. As described herein, the process may be commenced automatically or manually by the operator. This starts phase 1 of the multi-phase cleaning process corresponding to cleaning a first section or area of the robotic kitchen system. Examples of sections to clean in phase 1 of the multi-phase cleaning process include several key areas and components within the robotic kitchen system. One such area is the tops of the fryers, which frequently accumulate crumbs and grease. These substances often result from oil and food particles dripping through the fryer baskets during cooking operations. Regular and thorough cleaning of the fryer tops is essential to prevent buildup, ensuring hygienic conditions and optimal fryer performance. Additionally, the cleaning process addresses the fryer baskets and their associated markers. These components can become coated with oil and residual food materials over time. Proper cleaning of the baskets and markers is crucial for maintaining consistent cooking performance. It also plays an important role in reducing the risk of cross-contamination, thereby promoting food safety within the kitchen environment. Moreover, the system includes cleaning for drip trays, which are strategically positioned to collect excess oil and other liquids. Drip trays help in managing spillovers and maintaining a cleaner workspace. The robotic kitchen assistant is programmed to automatically clean these trays, minimizing potential spills and safety hazards while ensuring the workspace remains tidy and organized.

Step 320 states move to section 1. As described above, the robotic arm retrieves the cleaning tool and moves it to section 1.

Step 330 states to scrub section 1. In embodiments, the robotic arm is operable to move the cleaning tool across (namely, wipe) the surface of section 1. In some embodiments, the robotic arm is programmed and operable to move the cleaning tool in a short repetitive circular (or back and forth) motion across the first section.

In embodiments, the processor includes logic rules to apply a particular type of motion (e.g., circular, linear, back and forth, zig-zag, etc.) based on the type of mess or a character or property detected of the mess. For embodiments, if the detected mess is grease-based, a repetitive circular pattern is applied.

Step 340 states to confirm section 1 is clean. This step is performed by the processor and based on either (a) actual time elapsed for the scrubbing step (e.g., assume surface is cleaned after X minutes, where X ranges from 1 to 10 minutes) or (b) real-time image data arising from the sensors. The determination of whether a section is clean based on image data can be performed as described above in connection with step 110.

Step 350 queries whether to commence phase 2 or reclean section 1 based on the results from step 340. If the results are to reclean, then the process returns to step 320 and the first phase is repeated. In embodiments, the repeated scrub or brush pattern is different from the previous scrub pattern. For example, if the first scrub applied a circular pattern, the second scrub applies a linear scrub.

If the results from step 340 confirm section 1 is cleaned, the process moves to phase 2 for cleaning section 2. The steps for phase 2 are identical to that of phase 1 except the cleaning tool is operated on a different physical section of the robotic kitchen system.

Once phase 2 is completed, the method continues to phase 3 to clean section 3.

The process can be continued for n phases until the entire robotic kitchen system is cleaned according to the rules set forth herein.

Optionally, a cleaning tool evaluation step can be performed to interrogate the quality of the cleaning tool. The cleaning tool evaluation can be performed by staging the cleaning tool for the cameras to collect image data. The computer then evaluates whether the cleaning tool is acceptable for use or too dirty or otherwise damaged. This cleaning tool evaluation step may be performed on a schedule, between phases, or if a phase is not able to achieve adequate cleaning. In such cases, the cleaning tool is swapped for a new cleaning tool and the cleaning phase is repeated.

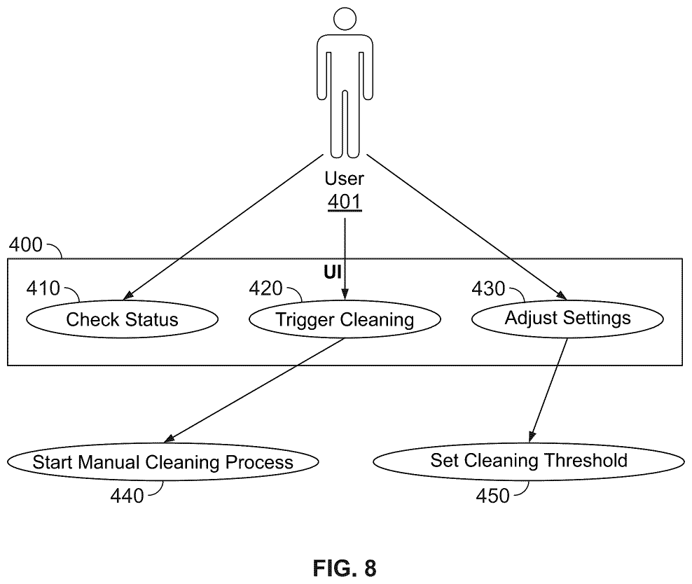

FIG. 8 is an illustration of a user interface 400 for a self-cleaning robotic kitchen system in accordance with embodiments of the invention.

The user interface 400 is shown including several windows or tabs including check status 410, trigger cleaning 420, and adjust settings 430. The user interface may be implemented on a touch screen display or control panel arranged on the front of the enclosure 11.

Check status 410 allows the user 401 to view the cleaning status including options such as ready, in progress, or completed. In some embodiments, status can include status for specific areas such as, e.g., Section 1: completed; Section 2: in progress.

Trigger cleaning 420 allows the user 401 to commence cleaning manually (namely, 440). By pressing the trigger cleaning window on the display, the robotic arm commences the cleaning pre-defined cleaning scheme as described herein.

Adjust settings 430 allows the user to adjust various settings and properties of the cleaning schemes. For example, the user 101 can adjust or set the cleaning threshold value as discussed herein.

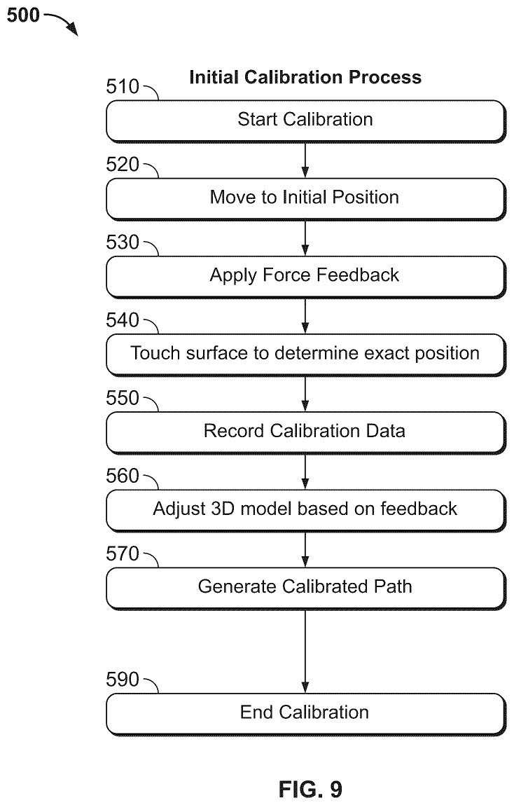

FIG. 9 is a flow chart of a process 500 for calibrating a robotic kitchen cleaning system in accordance with another embodiment of the invention.

Step 510 states to start calibration. In embodiments, the system includes a calibration module or program which is commenced by the user via the user interface (e.g., a tablet or computer). For embodiments, the calibration step is performed when equipment is installed or replaced or moved in any way. Additionally, calibration may be performed periodically or based on use of the appliances. The more the appliances are used, the more often the robotic cleaning system should be calibrated.

Step 520 states move to an initial position. This step is performed by the robotic arm (and cleaning tool) moving to a first known calibration position of a 3D model of the fryer or housing walls or frame. For example, the first calibration position may be the corner of the fryer to be cleaned or a corner of the robotic enclosure.

Step 530 states apply force feedback. This step is performed by the internal robotic arm motors and sensors to detect the approximate 3D location of the arm as the robotic arm makes contact with the surface.

Step 540 states touch surface to determine exact position. This step is performed by manually moving the robotic arm (and cleaning tool) to touch the surface of the appliance at a first calibration location (e.g., the corner of a vat of the fryer). Depending on which cleaning tool is being held, this 3D position may vary. As the arm is moved, the motor sensors in the arm and optionally the camera sensors continuously compute the 3D position of the arm.

In embodiments, a marker is arranged on the known position of the appliance or door frame, and the cleaning tool is moved to touch the marker or mark on the appliance.

Step 550 states record calibration data. Once the arm is in the desired position, and touching the target location of the surface of the appliance, the 3D position is recorded or saved for the robot arm, appliance, cleaning tool, and 3D model. Preferably, steps 520 through 550 are repeated for multiple calibration points.

Step 560 states adjust the 3D model based on the feedback. This step is performed by the processor comparing the predicted 3D location(s) arising from the 3D model with the actual calibrated position information from steps 540, 550. The 3D model is adjusted based on actual calibrated location to match the predicted 3D location with the measured location. In embodiments, a 3D-to-3D transformation matrix is generated, which serves as a mathematical model to map the predicted 3D coordinates to the actual calibrated 3D coordinates of the robot arm, appliance, and cleaning tool. This transformation matrix is continuously updated with the calibration data obtained from steps 540 and 550. By doing so, the system ensures that any discrepancies between the initial predictions and the measured positions are minimized. This iterative process allows the transformation matrix to dynamically refine its accuracy, thereby enabling the robot kitchen assistant to adapt to variations or changes in the environment and maintain precise movements within the workspace.

Step 570 states generate a calibrated path. Once the 3D model has been adjusted, a new calibrated path can be generated. The calibrated path refers to the trajectory that the robotic arm will follow during the cleaning process, taking into account the precise dimensions and positions of the appliances and surfaces. This path is designed to ensure that the cleaning tool effectively reaches and cleans all designated surface areas without leaving any spots unattended. The calibrated path is generated by integrating the updated 3D model with the predefined cleaning parameters and the requirements specific to the kitchen environment. This procedure ensures that the robotic arm operates with optimal efficiency and accuracy, minimizing unnecessary movements and maximizing cleaning effectiveness. Such a path allows the robotic arm to adapt to variations in the environment and equipment placements, providing a robust solution for continuous, reliable cleaning over time.

Step 590 states end calibration. The robotic arm is now calibrated with the tools and appliances. Cleaning can proceed as described herein.

FIG. 10 is a flow chart of a process 600 for generating a cleaning path for a robotic kitchen cleaning system in accordance with an embodiment of the invention.

Step 602 states to start cleaning path generation. In embodiments, the system includes a path generation module or program which is commenced by the user via the user interface (e.g., a tablet or computer).

Step 604 states to retrieve 3D models. In embodiments a plurality of models is stored, optionally remotely stored and accessible via the internet and cloud computing. Examples of 3D models are 3D software models of fryers, grills, counters, refrigerators, dispensers, bins, etc. In embodiments, the 3D models are computer aided drawings (CAD) files or the like provided by the manufacturer of the appliances.

Step 606 states to get a 3D model of the fryer. In embodiments, the user inputs the appliance 3D model. In embodiments, the system detects the appliance, and requests the 3D model based on the detected appliance. In embodiments, the appliance is detected based on a computer vision or reading a barcode. Regardless of how the appliance is identified, step 606 gets the 3D model of the appliance(s) present in the current environment from the 3D models retrieved in step 604.

Step 608 states to get static 3D models of frames and doors. In embodiments, the process gets the 3D model of the robotic enclosure such as the frame and doors.

Step 610 queries whether to generate the path from a precomputed path or ‘on-the-fly.’

If the path is determined ‘on-the-fly’, the method proceeds to step 622 which states to analyze sensor data. Step 624 states capture real time sensor data. These steps are performed by obtaining image data from one or more cameras aimed at candidate locations that tend to become dirty. The data is analyzed for dirt and grease. Analysis can be performed based on trained machine learning models. The trained machine learning models (e.g., dirt evaluation models) are trained to provide a score for level of dirt or the need to clean.

Step 626 states compute path based on sensor data. This step may be performed by the processor computing where to clean based on scores computed in steps 622, 624.

Step 628 states generate dynamic cleaning path. This step is performed based on updating the computed path from step 626 periodically or by a triggering event. An example of a triggering event is when a computed score for dirt from step 622/624 exceeds a threshold. The offending point/area is added to the existing cleaning path.

In embodiments, the new offending point is appended to the end of the path. In other embodiments, a new path is generated including the new point, and the path is generated to include all the points and optimize cleaning time, or to reduce another cost such as minimizing distance between cleaning locations.

If, on the other hand, the path is precomputed, the method proceeds to step 630 which states to use the precomputed path. In embodiments, one of a plurality of predefined paths may be selected in view of the 3D appliance models and robotic enclosure or housing.

For embodiments, a pre-computed path for an appliance is a user-defined route along a surface of the appliance. An exemplary route for a fryer is a continuous path running clockwise along the perimeter of the fryer vat.

Regardless of whether the path is precomputed or determined on-the-fly, the process moves to step 640 to execute the cleaning path.

Step 650 states to move along the computed path. This step is performed by the robotic arm following the computed path from step 628 or step 630 as the case may be.

Step 660 states to clean the specified surfaces. This step is performed by the cleaning tool held by the arm. As the robotic arm moves along the computed path, the cleaning tool brushes or scrubs the surface as described herein.

Step 670 states to end path generation.

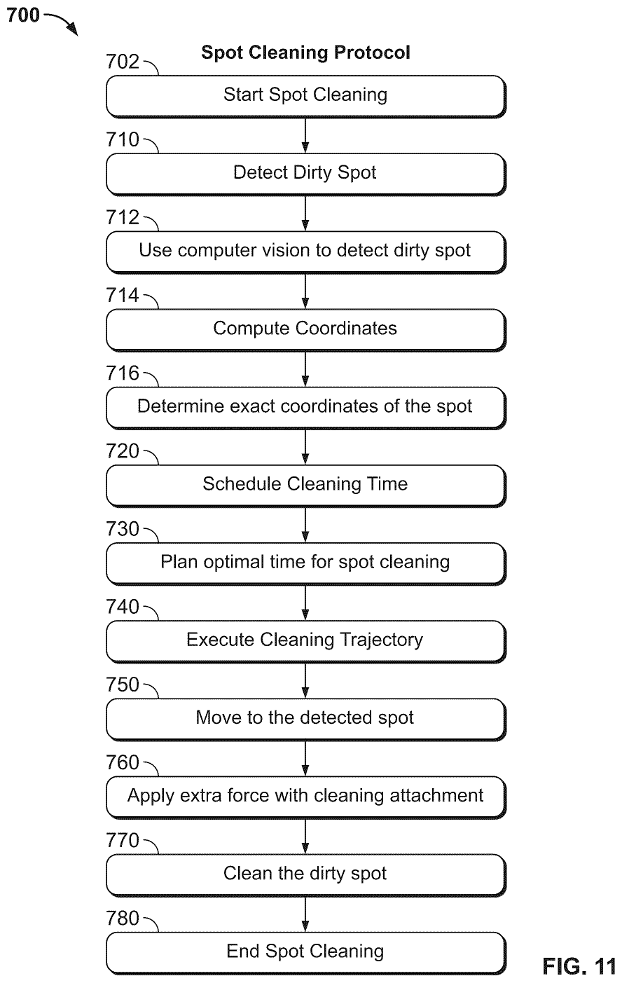

FIG. 11 is a flow chart of a process 700 for spot-cleaning using a robotic kitchen cleaning system in accordance with an embodiment of the invention.

Step 702 states start spot cleaning. In embodiments, the system includes a spot cleaning module or program which is commenced by the user via the user interface (e.g., a tablet or computer) or, as described herein, when a dirty spot is detected.

Step 710 states detect dirty spots. This step is performed with reference to step 712 by use of computer vision. Cameras aimed at the appliances and other surfaces obtain image data. The image data is evaluated by a trained ML model to detect dirt. Output from the trained dirt detection model could be a score or level of dirt or a mere classification of the region being dirty or clean.

In embodiments, the images are evaluated for ‘hot spots’ based on evaluating the intensity of the light recorded in the image. In lieu of ML-type algorithms which require training data sets, image thresholding is applied to determine whether a region is deemed dirty. If the cumulative intensity of an image exceeds a threshold, the region is deemed dirty.

Step 714 states compute coordinates. After the offending area is detected, its location is computed. In embodiments, and with reference to step 716, the exact coordinates of the spot are computed based on the image information from calibrated cameras. In embodiments, the cameras are calibrated with the robotic arm in advance of cleaning. In embodiments, the area of the spot is also computed.

Step 720 states schedule cleaning time. This step is performed by the computer based on customer orders. In embodiments, and with reference to step 730, the computer is programmed to compute an optimal time for cleaning the spot. In embodiments, the cleaning time is determined based on customer orders and estimated time to clean the spot. In embodiments, the cleaning can be performed between customer orders if there is adequate time between the orders.

Step 740 states execute the cleaning trajectory. In embodiments, this step is performed, with reference to step 750, by moving the robotic arm and cleaning tool to the detected spot.

Step 760 states supply extra force with cleaning attachment. In embodiments, this step is performed by the robotic arm manipulating the cleaning tool against the spot. The cleaning tool for spot cleaning is applied with a greater force than the regular route cleaning described herein. In embodiments, the spot cleaning is performed with a 100 to 200% greater force to the offending surface by the cleaning tool. In embodiments, the amount of extra force ranges from 0.1 to 5 LBS.

Step 770 states clean the dirty spot. This step can be performed by the robotic arm and cleaning tool. In embodiments, as described herein, the robotic arm applies a swiping or rotating motion with force to scrub the dirty spot. The system is programmed to move the cleaning tool into an initial position, and then to circulate or sweep across the dirty spot.

In embodiments, the scrubbed area is reviewed for determining whether to repeat steps 710-770 on the dirty spot. For embodiments, the process is repeated only on the portion remaining dirty.

### Alternative Embodiments

In embodiments, the end effectors of the robotic arm are operable to rotate or spin the cleaning tool. In embodiments, the end effector includes a motor in mechanical cooperation with the shaft of the cleaning tool to spin the cleaning tool about the shaft. In embodiments, the speed of rotation and amount of pressure applied to the target surface is adjusted based on the camera image data. For example, as scrubbing is being performed, the processor is programmed to evaluate the image data for a predetermined level of cleanliness and if the predetermined level is not reached within a time period, the speed and/or pressure applied by the robotic arm and cleaning tool is adjusted, typically increased, in order to enhance cleaning until the level of cleanliness is reached.

In embodiments, the vision system and processor are operable to detect a mess event corresponding to excessive spill, dirt, grease or debris according to a threshold level and in real time. The mess event is input to the scheduler module and the scheduler module applies a set of logic rules or optimization strategy to execute a cleaning process to cure the mess event within customer order queues. For example, if the oil used for cooking an order next-in-queue, the cleaning process will take priority over the next-in-queue order. Additionally, in view of the order schedule and operations, the cleaning process shall be limited to only one cleaning phase to clean only the offending section to cure the mess event.

In this manner, the schedule module includes cleaning input planning in scheduling cooking and meeting order demands.

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations; or operations in another order than that specifically described above. Additionally, any of the components and steps described herein may be combined with one another in any logical manner except where such components or steps would be exclusive to one another. Accordingly, the scope and spirit of the invention should be judged in terms of the claims, which follow as well as the legal equivalents thereof.

1. A self-cleaning robotic kitchen system, the self-cleaning robotic kitchen system operable to cook food using at least one appliance, the system comprising:
a cleaning tool;
at least one sensor or camera aimed at the appliance;
a robotic arm adapted to pick up the cleaning tool; and
a processor programmed and operable to:
determine whether to commence a first cleaning phase for cleaning a first section based on data arising from the at least one sensor or camera;
control pick up of the cleaning tool;
control the robotic arm to clean according to a predefined route or pattern to scrub the first section; and
dock the cleaning tool if the first section is clean.

2. The system of claim 1, wherein the cleaning tool comprises a base and a cleaning cartridge, and wherein the robotic arm is operable to grip the base.

3. The system of claim 1, wherein the cleaning cartridge is cone-shaped.

4. The system of claim 1, wherein the cleaning cartridge is detachable from the base.

5. The system of claim 1, wherein the appliance is a fryer.

6. The system of claim 4, further comprising a waste bin for collecting the cleaning cartridge, and wherein the waste bin comprises a detent for detaching the cartridge from the cleaning tool body.

7. The system of claim 4, wherein the cleaning tool body further comprises ejector pins to eject the cartridge from the cleaning tool body.

8. The system of claim 1, wherein the processor is operable to evaluate whether to clean multiple sections of the robotic workspace based on image data arising from the sensor.

9. The system of claim 8, wherein the processor is operable to control cleaning of each of the multiple sections.

10. The system of claim 1, wherein the processor is further operable to compute a schedule to cook customer orders, and to schedule cleaning based on the customer orders and image data from the sensors.

11. The system of claim 1, wherein determining whether to clean is based on a predefined threshold level, and whether a value computed from the image data is greater than the predefined threshold value.

12. A robot automated method for cleaning a surface in a robotic kitchen workspace, the method comprising:
determining whether to commence a first cleaning phase for cleaning a first section based on image data arising from at least one sensor or camera;
picking up a cleaning tool;
controlling a robotic arm to clean according to a predefined route or pattern to scrub the first section using the cleaning tool;
querying whether first section is clean subsequent to the controlling step; and
docking the cleaning tool if the first section is clean.

13. The method of claim 12, wherein the robotic arm grips the cleaning tool by a base of the cleaning tool.

14. The method of claim 13, further comprising detaching a cleaning cartridge from the base of the cleaning tool.

15. The method of claim 14, further comprising a waste bin for collecting the cleaning cartridge, and wherein the waste bin comprises a detent for detaching the cartridge from the cleaning tool body.

16. The method of claim 14, wherein the cleaning tool body further comprises ejector pins to eject the cartridge from the cleaning tool body.

17. The method of claim 12, further comprising evaluating whether to clean multiple sections of the robotic workspace based on image data arising from the sensor.

18. The method of claim 17, further comprising generating paths and controlling the motion to clean the multiple sections.

19. The method of claim 12, further comprising computing a schedule to cook customer orders, and to schedule cleaning based on the customer orders and image data from the sensors.

20. The method of claim 12, further comprising computing whether to clean is based on a predefined threshold level, and whether a value computed from the image data is greater than the predefined threshold value.
